(19) United States
(12) Patent Application Publication
(10) Pub. No.: US 2016/0255825 A1
(43) Pub. Date: Sep. 8, 2016

(54) Cover for Weed Spraying Devices

(71) Applicant: Dale Quam, Tekin, ND (US)

(72) Inventor: Dale Quam, Tekin, ND (US)

(21) Appl. No.: 14/948,950

(22) Filed: Nov. 23, 2015

Related U.S. Application Data
(60) Provisional application No. 62/128,720, filed on Mar. 5, 2015.

(51) Int. Cl. A01M 7/00

(52) U.S. Cl. CPC A01M 7/0064

(57) ABSTRACT

A cover for a weed sprayer for restricting the spray dispersed by the weed sprayer to a confined area. The cover includes a housing having an open lower end, at least one upstanding sidewall, and an upper end, defining an interior volume. The housing can be placed over one or more weeds so as to enclose the weeds therein. The upper end of the housing includes an opening thereon through which the nozzle of a weed sprayer can be positioned. Thus, when the user utilizes the weed sprayer, the spray dispersed thereby is limited to the interior volume of the housing. This helps to prevent the spray from contacting desirable plant life, such as flowers, that are in close proximity to the weeds desired to be removed.

### CROSS REFERENCE TO RELATED APPLICATION

This application claims the benefit of U.S. Provisional Application No. 62/128,720 filed on Mar. 5, 2015. The above identified patent application is herein incorporated by reference in its entirety to provide continuity of disclosure.

### BACKGROUND OF THE INVENTION

### Field of the Invention

The present invention relates to covers for weed sprayers. More specifically, the present invention provides a cover for a weed sprayer that serves to restrict the area in which the weed spray is dispersed by the weed sprayer. The present invention comprises a housing having an open lower end, upstanding sidewalls, and an upper end having an opening through which the nozzle of a weed sprayer can be positioned. With the nozzle of the weed sprayer inserted into the opening of the housing, the spray dispersed thereby is limited to the area defined by the housing, preventing flowers and other plants from being contacted by the chemical weed killing spray.

It is often necessary to utilize weed killing sprays in order to eliminate or inhibit the growth of weeds and other undesirable plant-life. Weeds develop spontaneously in outdoor areas, detracting from the appearance of the landscape. Further, weeds can be harmful to other plant-life and the weeds may spread if not properly controlled. Lawns, yards, gardens, and various other outdoor areas are often cared for in order to maintain a desired appearance to enhance the look of the property and of the buildings thereon. Thus, it is important to remove weeds and other undesirable plant-life.

Weed killing sprays are often used to kill weeds and prevent their future growth. However, weed killing sprays may also be harmful to desirable plant life, such as flowers and shrubbery. As a result, some flowers and other desirable plant life may be damaged by the weed spray as a user attempts to eliminate weeds. Many weed spraying devices spray a wide, fine mist of a weed killing chemical, and as a result, the chemical may be deposited on desirable plant life. Thus, a device for restricting the area contacted by weed killing spray is desired in order to prevent flowers and other plant-life from being contacted by the chemicals.

Devices have been disclosed in the prior art that relate to covers for weed sprayers. These include devices that have been patented and published in patent application publications. These devices generally relate to spraying devices having a funnel or hood disposed about the nozzle thereof for directing the spray dispensed thereby, such as U.S. Pat. No. 2,644,717, U.S. Pat. No. 2,709,112, U.S. Pat. No. 2,552,352, U.S. Pat. No. 4,013,225, U.S. Pat. No. 4,767,056, and U.S. Pat. No. 6,065,244.

These prior art devices have several known drawbacks. The devices in the prior art relate to spray nozzles having specific construction for dispensing spray therefrom. These devices fail to provide a housing adapted to enclose one or more weeds so as to separate the weeds from other plant-life. Further, the devices in the prior art are not adapted to receive the nozzle of a spraying device therein and do not serve to constrain or limit the area in which the spray is dispensed.

In light of the devices disclosed in the prior art, it is submitted that the present invention substantially diverges in design elements from the prior art and consequently it is clear that there is a need in the art for an improvement to existing cover devices for weed sprayers. In this regard the instant invention substantially fulfills these needs.

### SUMMARY OF THE INVENTION

In view of the foregoing disadvantages inherent in the known types of covers for weed sprayers now present in the prior art, the present invention provides a new cover for a weed sprayer wherein the same can be utilized for providing convenience for the user when restricting the area in which weed killing spray is dispersed.

It is therefore an object of the present invention to provide a new and improved cover for a weed sprayer comprising a housing having an open lower end, upstanding sidewalls, and an upper end having an opening through which the nozzle of a weed sprayer can be inserted.

It is another object of the present invention to provide a cover for a weed sprayer comprising a housing adapted to be placed over one or more weeds in order to restrict weed spray dispersed by a weed sprayer to the area defined by the housing.

Another object of the present invention is to provide a cover for a weed sprayer comprising a housing having a circular cross section.

Yet another object of the present invention is to provide a cover for a weed sprayer comprising a housing that tapers from a lower end thereof to an upper end thereof.

Another object of the present invention is to provide a cover for a weed sprayer that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1A shows a perspective view of the cover for a weed sprayer.

FIG. 1B shows a perspective view of the lower end of the cover for a weed sprayer.

FIG. 2 shows a cross sectional view of the cover for a weed sprayer in use.

### DETAILED DESCRIPTION OF THE INVENTION

Reference is made herein to the attached drawings. Like reference numerals are used throughout the drawings to depict like or similar elements of the cover for a weed sprayer. For the purposes of presenting a brief and clear description of the present invention, the preferred embodiment will be discussed as used for limiting the spray dispersed by a weed sprayer to a confined area. The figures are intended for representative purposes only and should not be considered to be limiting in any respect.

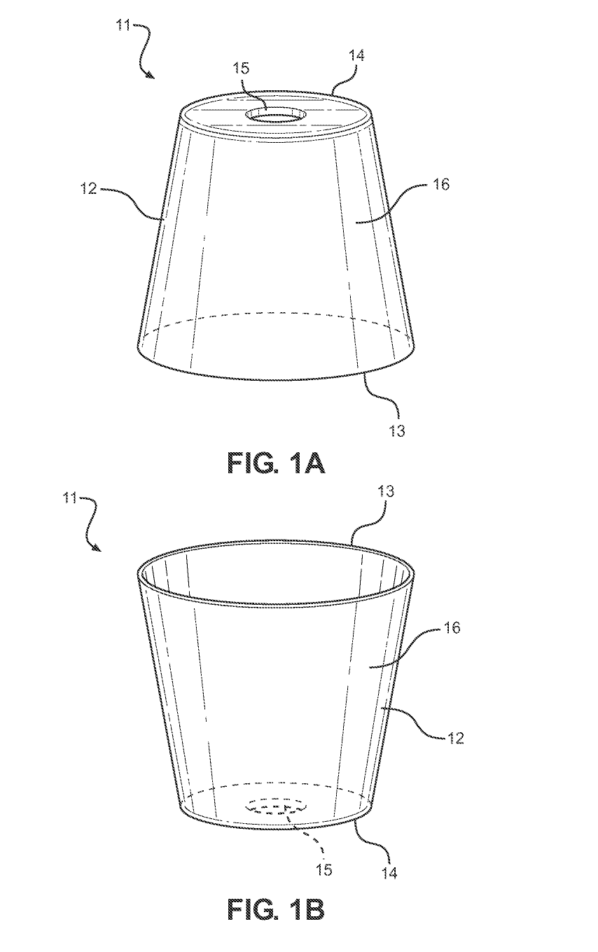

Referring now to FIGS. 1A and 1B, there are shown perspective views of the upper end and lower end of the cover for a weed sprayer, respectively. The cover 11 comprises a housing 12 having an open lower end 13, upstanding sidewalls, and an upper end 14, defining an interior volume 16. The upper end 14 includes an opening 15 thereon through which the nozzle of a weed sprayer can be inserted. In this way, the spray dispersed by the weed sprayer is limited to the interior volume 16 of the housing 12, and the spray will not be deposited on area outside of the housing 12. Thus, the user can position the housing 12 over one or more weeds in order to ensure that only those weeds will be contacted by the spray dispensed by the weed sprayer.

The housing 12 preferably comprises a circular cross section. However, in alternate embodiments, the housing 12 can have other cross sections such as a square or rectangular cross section, among others. Further, the housing 12 tapers from the lower end 13 thereof to the upper end 14 thereof. In this way, the lower end 13 of the housing 12 is wider than the upper end 14 thereof. The nozzle of the weed sprayer dispenses a cone of spray that widens as the spray moves farther from the weed sprayer. Thus, the housing 12 comprises a tapering construction so that that lower end 13 of the housing 12 is wider than the upper end 14 so as to account for the manner in which spray is dispensed by the weed sprayer.

The housing 12 is composed of any suitable durable, waterproof material. Preferably, the material is lightweight and semi-rigid. Further, the housing 12 is preferably transparent or translucent so that the user may see into the interior volume 16 thereof. This allows the user to see the area enclosed by the housing 12, and allows the user to see if all of the weeds within the housing 12 have been contacted by the spray. The housing 12 may also be constructed so as to be resistant to weed spraying chemicals, so that the housing 12 does not become damaged or degrade from repeated exposure to weed spraying chemicals.

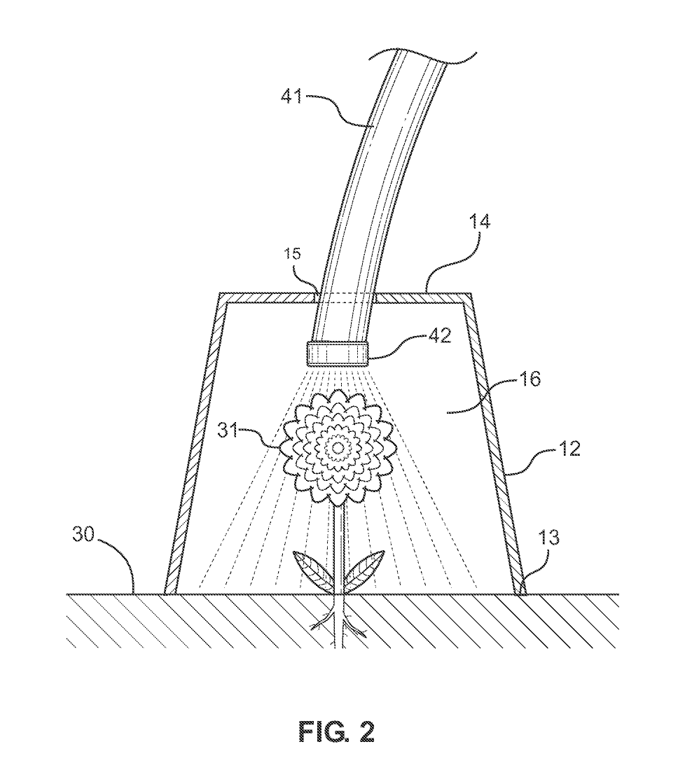

Referring now to FIG. 2, there is shown a cross sectional view of the cover for a weed sprayer in use. In operation, the cover 11 is positioned over one or more weeds 31 so that the weeds 31 are enclosed within the interior volume 16 of the housing 12. The lower end 13 of the housing 12 is positioned flush against the ground so as to enclose the weeds 31 therein. The nozzle 42 of a weed sprayer 41 is inserted through the opening 15 on the upper end 14 of the housing 12 so that the weed sprayer 41 can disperse a weed killing spray into the interior volume 16 of the housing 12. As the spray is dispersed, the spray is confined to the interior volume 16 of the housing 12 so that plants outside of the housing 12 are protected from the weed killing spray.

The opening 15 on the upper end 14 of the housing 12 is sized so as to allow the nozzle 42 to pass therethrough. However, in some embodiments, the opening 15 is sized so that the opening 15 fits snugly around the exterior of the nozzle 42 so that the housing 12 is removably secured to the nozzle 42. In this way, the housing 12 can be attached and detached to the weed sprayer 41 by a frictional fit therewith.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A cover for a weed sprayer, comprising:
a housing having an open lower end, at least one upstanding sidewall, and an upper end, defining an interior volume;
an opening disposed on said upper end adapted to allow a nozzle of a weed sprayer to be positioned therein;
wherein said housing tapers from said open lower end towards said upper end.

2) The cover for a weed sprayer of claim 1, wherein said housing is composed of a transparent material.

3) The cover for a weed sprayer of claim 1, wherein said housing is composed of a translucent material.

4) The cover for a weed sprayer of claim 1, wherein said housing comprises a circular cross sectional area.
